(19) United States
(12) Patent Application Publication
(10) Pub. No.: US 2007/0153815 A1
(43) Pub. Date: Jul. 5, 2007

(54) System and Method For Establishing And Maintaining Simultaneous Operation of Asynchronous and Isochronous Communications

(76) Inventors: George Geeyaw She, Pittsford, NY (US); James Dean Allen, Greece, NY (US); James Charles Stoffel, Rochester, NY (US)

Correspondence Address: ROBERT D. GUNDERMAN, JR.;PATENT TECHNOLOGIES, LLC, 150 LUCIUS GORDON DRIVE, SUITE 205, WEST HENRIETTA, NY, 14586, US

(21) Appl. No.: 11/614,972

(22) Filed: Dec. 21, 2006

Related U.S. Application Data
(60) Provisional application No. 60/755,232, filed on Dec. 30, 2005.
(60) Provisional application No. 60/771,097, filed on Feb. 7, 2006.

(51) Int. Cl. H04L 12/56; H04J 3/16

(52) U.S. Cl. 370/401; 370/466

(57) ABSTRACT

A digital communication system and method for establishing and maintaining simultaneous operation of asynchronous and isochronous communications over the same or different physical communication media. The system includes a Multimode Network Controller having connections to multiple asynchronous and isochronous information sources, two or more normally non-interoperable Member Devices using different native protocols to communicate with the Multimode Network Controller over different wired and wireless physical communication media (or channel), and an algorithm that uses the Time Division Multiple Access technique to enable simultaneous operation of asynchronous and isochronous communications. Some embodiments of the present invention include an algorithm to enable a Member Device to have sub-network controller functions. The system in some embodiments of the present invention may include algorithms that enable the Multimode Network Controller to control and coordinate a transfer of information from information sources to Member Devices over different physical media or through one or more sub-networks.

### CROSS-REFERENCE TO RELATED PATENT APPLICATIONS

This application claims the benefit of the filing dates of U.S. Provisional patent applications Ser. No. 60/755,232 filed on Dec. 30, 2005 and Ser. No. 60/771,097 filed on Feb. 7, 2006.

### BACKGROUND OF THE INVENTION

1. Field of the Invention

This invention relates generally to wireless multi-media systems, and more particularly to a system and method for establishing and maintaining simultaneous operation of asynchronous and isochronous communications within a TDMA (Time Division Multiple Access) based communication system.

2. Description of Related Art

The home, office, and other locations are becoming increasingly filled with various electronic communication systems, with both wired and wireless communication network installations experiencing significant growth in recent years. Unfortunately, most of these communication systems are incompatible or non-interoperable. They often interfere with each other and compete for resources, such as access and bandwidth. In a typical home or office building, the ability to access the Internet is normally accomplished by connecting computers to an Internet Service Provider (ISP) using specialized communication equipment, such as broadband cable modems or broadband DSL (Digital Subscriber Loop) modems. The broadband cable or DSL modem is usually co-located at the location where the cable or DSL access line enters the building. To allow multiple computing devices in different parts of the building to access the Internet, the broadband cable or DSL modem is normally connected to a wired/wireless router, wireless access point or other access distribution devices, over different types of physical media (or physical channels), such as CAT5 Ethernet wire, RG6 coaxial cable, power line, and radio frequency (RF). To further complicate the networking systems within homes or office buildings, the proliferation of content collection from various content sources (such as the Internet, satellite and cable operators, DVR (Digital Video Recorder), portable MP3 players, etc.) and distribution to different content consuming devices (such as TV, stereo systems, computers, etc.) have prompted consumers and manufacturers to use new or existing communication networks and technologies in an attempt to accomplish the goal of a “connected home.” This attempt often resulted in a partially accomplished goal but at a very high cost to consumers with no or little guaranteed quality of service (QoS).

As consumers add different components to their home networks, those home networks become amalgamations of wireless and wired sub-networks. However, each sub-network may have its own distinct protocol to enable communication between its networked devices. This creates a problem because there is no simple system that can bridge communications among end user wireless sub-networks and wired sub-networks. It is foreseeable that future devices will be incompatible with still newer network protocols and systems and such new devices will be incompatible with prior systems using older protocols, resulting in greater interference among communication systems that share the same medium (wired and wireless), such that the end user's communication channel throughput will be seriously reduced and overall communication will be impaired. Under such circumstances, for applications that require a “guarantee of data delivery in a fixed period of time” (isochronous system), such as a high quality High Definition (HD) TV stream, it is difficult to maintain quality of service (QoS) and may result in broken images, delayed video frames, and out-of-sync audio. There is, therefore, a problem with multiple, independent communication networks that interfere with one another, degrade performance, and do not scale over time to larger systems designed to meet higher bandwidth requirements.

Proposed solutions for these problems include combining the networks into a common protocol or separating the sub-networks in time, code, frequency, or by other means. In applications where the intention is to bridge networks of different protocols, this traditionally requires multiple communication channels (wires or RF channels), or the ability to create “neighbor” or sub-networks, which are coordinated with sharing of the same physical channel but not the data carried by the individual networks. Additionally, any proposed solution must also provide appropriate networking protocols to the designated devices, so the QoS level can be maintained for the isochronous system, while meeting the demand expectation of the asynchronous system users.

It is therefore an object of the present invention to provide a system and method for solving the aforementioned problems associated with incompatible communication systems and networks that share the same physical transmission medium (or physical channel), wired or wireless, by allowing those systems to communicate using their respective native protocols during the time slots scheduled by the TDMA (Time Division Multiple Access)-based system (i.e., the preferred system). As will become evident through this specification, the various embodiments of the present invention provide for: (1) A preferred communication architecture and design enabling highly reliable isochronous communications in a multi-system environment; (2) a preferred system design providing a mechanism to enable multiple, non-interoperable asynchronous and isochronous communication networks to operate concurrently on a time-multiplexing basis over the same physical medium; (3) the preferred system design providing for efficient utilization of channel and bandwidth; (4) the preferred system design enabling the network to adapt to existing communication systems and maintaining backward compatibility; (5) the preferred system design enabling the network to adapt to the future addition of classes of asynchronous and isochronous systems and maintaining a degree of forward compatibility; (6) the preferred system design providing a cross-protocol-network-bridging mechanism for an application or communication link to be established across distinct network systems, thus enabling, for example, Wi-Fi systems to communicate in a wireless network and also through a cable network in the same environment; (7) the preferred system design enabling a “fail-over” operation to provide more reliable communications; (8) the preferred system design enabling network traffic of asynchronous nature, such as Internet traffic, to be simultaneously disbursed to both asynchronous and isochronous channels; (9) the preferred system design providing a mechanism to aggregate adjacent physical (or radio frequency, RF) channels in wireless transmissions for increased network throughput; (10) the preferred system design providing a mechanism for improved battery life for portable devices used in this environment; and (11) the preferred system design providing a mechanism to create bridge or sub-networks for extended range.

### BRIEF SUMMARY OF THE INVENTION

A digital communication system for establishing and maintaining simultaneous operation of asynchronous and isochronous communications, the system comprising network nodes and connections to multiple asynchronous and isochronous information sources, the network nodes including a Multimode Network Controller (MNC) and a plurality of normally non-interoperable Member Devices (MD) with different native protocols, the Multimode Network Controller (MNC) comprising means for controlling and coordinating transfer of information from information sources to said member devices.

The foregoing paragraph has been provided by way of introduction, and is not intended to limit the scope of the various embodiments of the present invention as described in this specification and the appended claims.

### DESCRIPTION OF THE DRAWINGS

The invention will be described by reference to the following drawings, in which like numerals refer to like elements, and in which:

FIG. 1 depicts an exemplary environment of a typical wireless home network using Wi-Fi for information transfer between the Internet and portable computers.

FIG. 2 depicts an exemplary environment of a typical wired home network using Power Line Communication (PLC) for information transfer between the Internet and computers on the PLC network.

FIG. 3 depicts an exemplary environment using the preferred digital communication system with a Multimode Network Controller (MNC).

FIG. 4 depicts an exemplary multimode superframe structure that supports both asynchronous and isochronous network traffic concurrently.

FIG. 5 depicts an example of multiplexing multiple isochronous data transfers within a single Isochronous Allocated Channel Time (IACT)

FIG. 6 depicts an example of access architecture for a Wi-Fi system.

FIG. 7 depicts an exemplary functional architecture of a Multimode Network Controller (MNC).

FIG. 8 depicts a flow chart for the address translation process.

FIG. 9 depicts a diagram of a sub-network communicating with the Multimode Network Controller (MNC).

The present invention will be described in connection with a preferred embodiment; however, it will be understood that there is no intent to limit the invention to the embodiment described. On the contrary, the intent is to cover all alternatives, modifications, and equivalents as may be included within the spirit and scope of the invention as defined by this specification and the appended claims.

### DESCRIPTION OF THE PREFERRED EMBODIMENTS

For a general understanding of the present invention, reference is made to the drawings. In the drawings, like reference numerals have been used throughout to designate identical elements.

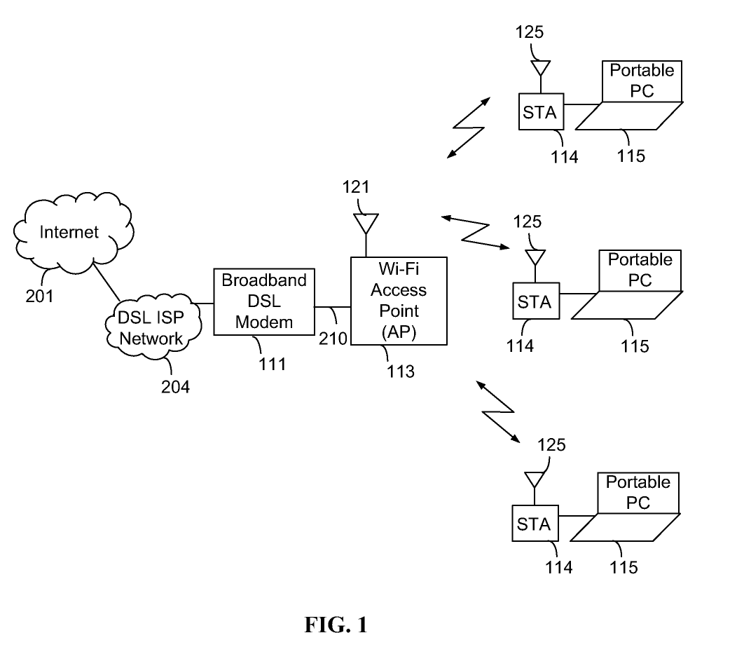

Referring to FIG. 1, a typical wireless home network using IEEE 802.11 based Wi-Fi technologies is shown, allowing a plurality of Portable PCs 115 at different locations to access the Internet 201 wirelessly. The Portable PC 115 uses an external or embedded STA (Station) 114 and the STA Antenna 125 to communicate with the Wi-Fi Access Point (AP) 113 over a specific radio frequency (RF) channel. The Wi-Fi Access Point (AP) 113 normally has an Access Point (AP) Antenna 121 attached to it, which may have a different shape or form factor than the Station (STA) Antenna 125. The Wi-Fi Access Point (AP) 113 is connected to a Broadband DSL Modem 111 (or a Broadband Cable Modem) over a CAT5 (category 5 or 5e) Ethernet wire 210 or similar. The Broadband DSL Modem 111 connects to the Internet 201 via an ISP (Internet Service Provider) Network 204 provided by a Digital Subscriber Line (DSL) service operator. Typical Internet information transfer, like file transfer and email, is of asynchronous nature, in which the delivery of data to its intended destinations is not time constrained. When used for file transfer or Internet browsing, the Portable PC 115 is referred to as the Asynchronous Member Device (AMD).

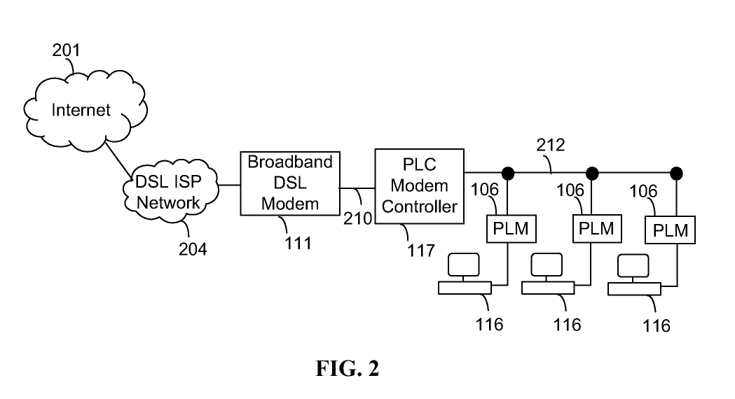

Turning now to FIG. 2, another example of a home network using the Power Line Communication (PLC) system is shown, allowing Desktop Computers 116 to access the Internet 201 using the existing power line/electrical wiring in the structure (or Power Line Medium 212) and Digital Subscriber Line (DSL) service. Similar to the wireless home network in FIG. 1, the Power Line Communication (PLC) Modem Controller 117 and Power Line Modem (PLM) 106 in FIG. 2 replace the Wi-Fi Access Point 113 and the Station (STA) 114 in FIG. 1, respectively. The Power Line Communication (PLC) Modem Controller 117 connects to the Internet 201 over the Broadband Digital Subscriber Line (DSL) Modem 111 and the Digital Subscriber Line (DSL) Internet Service Provider (ISP) Network 204, and transfers the Internet data over the Power Line Medium 212 in a building structure to the Desktop Computers 116 via the Power Line Modem (PLM) 106. The Power Line Modem (PLM) 106 plugs into a wall outlet and normally sets itself up to communicate with the Power Line Communication (PLC) Modem Controller 117. The Desktop Computer 116 is normally connected to the Power Line Modem (PLM) 106 via an Ethernet or USB cable.

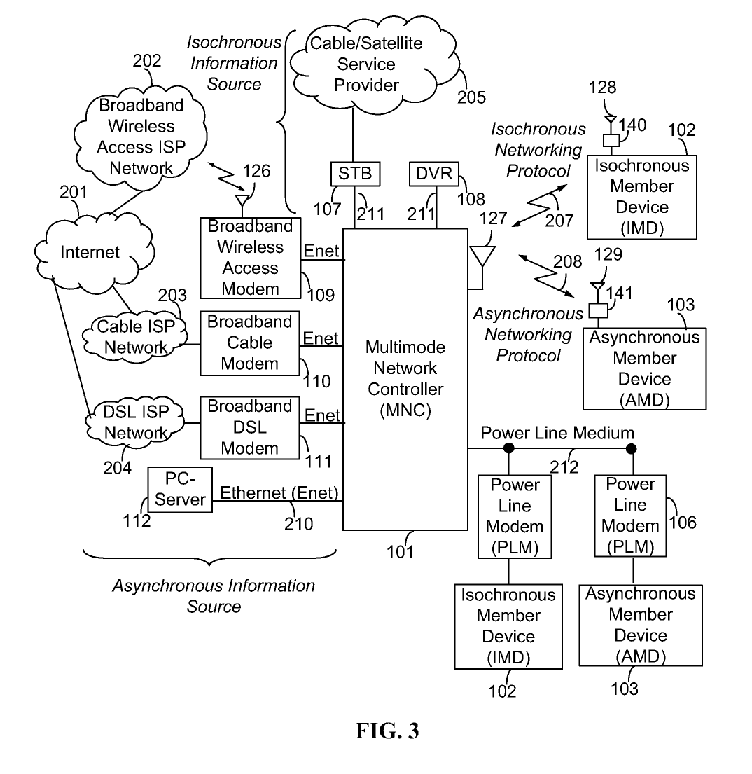

Turning now to FIG. 3, an application diagram using the Multimode Network Controller (MNC) 101 is shown. In this application environment, the Multimode Network Controller (MNC) 101 is capable of receiving IP (Internet Protocol)-based asynchronous information, such as file transfers from the PC-Server 112 over the Ethernet 210, or data from the Internet 201 using the existing wired Broadband Cable Modem 110 or Broadband Digital Subscriber Line (DSL) Modem 111 connection, or the wireless connection via the IEEE 802.16 or comparable Broadband Wireless Modem 109, from their respective Cable ISP Network 203, Digital Subscriber Line Internet Service Provider (DSL ISP) Network 204, or Broadband Wireless Internet Service Provider (ISP) Network 202 (using the attached Broadband Wireless Antenna 126). At the same time, the Multimode Network Controller (MNC) 101 can also receive QoS (Quality of Service)-demanding multimedia content of isochronous nature over an analog or digital Audio-Video Link (AVL) 211 from the Digital Video Recorder (DVR) 108, or cable/satellite Set-Top Box (STB) 107 for the subscription-based content from the Cable/Satellite Service Provider 205. The Multimode Network Controller (MNC) 101 can simultaneously distribute both Internet and multimedia information to different Asynchronous Member Devices (AMD) 103 and Isochronous Member Devices (IMD) 102, both wired and wireless, using asynchronous and isochronous protocols, respectively. The Multimode Network Controller (MNC) 101 uses the Multimode Network Controller (MNC) Antenna 127 for wireless communications with Member Devices (MDs), while wired communications may be achieved by means of Power Line Medium 212 or Ethernet 210 connections. An example of a Wireless Isochronous Member Device (WIMD) is an Isochronous Member Device (IMD) 102 with a connection to an internal (e.g., embedded) or external Isochronous Member Device (IMD) Radio Transceiver 140 having an Isochronous Member Device (IMD) Antenna 128 attached to it, whereas a Wireless Asynchronous Member Device (WAMD), such as a Wi-Fi Station (STA) 114 shown in FIG. 1 is an Asynchronous Member Device (AMD) 103 with a connection to an internal (e.g., embedded) or external Asynchronous Member Device (AMD) Radio Transceiver 141 having an Asynchronous Member Device (AMD) Antenna 129 attached to it (e.g., a Wi-Fi Station (STA) 114 shown in FIG. 1.

The present invention provides a method for connecting multiple, otherwise incompatible member devices to one or more asynchronous or isochronous information sources, as shown in FIG. 3. The method uses Time Division Multiple Access (TDMA) techniques. One method of the present invention operates the Multimode Network Controller (MNC) 101 to establish a single logical communication channel with each member Device (MD), the logical communication channel being time synchronized and repeated at a pre-determined interval. The method further provides that the repetitive logical communication channel, also known as a superframe, comprises a Synchronous Beacon Signal (SBS) and one or more time slots, also known as Allocated Channel Time (ACT).

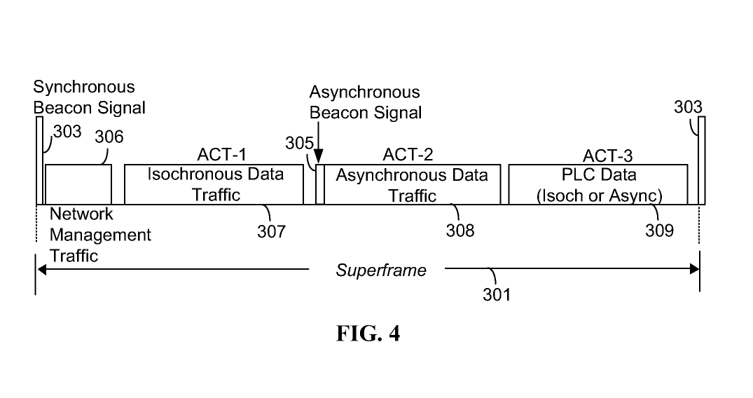

Referring now to FIG. 4, a preferred system superframe structure is shown, which can simultaneously support both asynchronous and isochronous traffic types. The preferred system comprises the TDMA (Time Division Multiple Access)-based communication system architecture, in which predefined (or requested) time is assigned between framing signals (e.g., beacons and/or end-of-frame indicators) for Member Devices (MDs) on the network, so they can communicate with one another and/or with the Multimode Network Controller (MNC) 101. The TDMA (Time Division Multiple Access) protocol usually comprises three elements: (1) A Synchronous Beacon Signal (SBS) 303 transmitted by the Multimode Network Controller (MNC) 101 for starting a network, for timing synchronization of the network frame cycle or “Superframe” 301, and for notifying the Member Devices (MDs) when they can start communicating; (2) an association mechanism that allows the Member Devices (MDs) to join or leave the network; and (3) time slots (or Allocated Channel Time, ACT) for carrying the permitted traffic. In an Allocated Channel Time (ACT) reserved for isochronous communications (i.e., ACT-1 307), such as audio and video streaming between two or more Isochronous Member Devices (IMD) 102, the same amount of the time slot is repeated at a fixed, predefined interval, so the application can precisely predict its latency and performance, thereby meeting the committed QoS level.

The preferred system superframe structure of FIG. 4 can also allocate one or more time slots within the same Superframe 301 for asynchronous communications, such as Wi-Fi (IEEE 802.11) or PLC (Power Line Communication), where the delivery of the data is not time constrained. In an Allocated Channel Time (ACT) reserved for asynchronous communications (i.e., ACT-2 308), the time slot can be used by Asynchronous Member Devices (AMD) 103 using their native Asynchronous Networking Protocol 208 (such as 802.11) and the entire signaling structure of that protocol can be carried forward within this Allocated Channel Time (ACT). For example, the time slot can start with an Asynchronous Beacon Signal (ABS) 305 as defined in such a native Asynchronous Networking Protocol 208. In order to manage the traffic and maintain QoS, the preferred system employs a Multimode Network Controller (MNC) 101, which is capable of handling both asynchronous and isochronous networking protocols. An Asynchronous Member Device (AMD) 103, such as existing 802.11 Stations (STA) 114, can listen to the physical medium and detect the Asynchronous Beacon Signal (ABS) 305 transmitted by the Multimode Network Controller (MNC) 101, and either receive the data or contend for access. Since data transfer using the Asynchronous Networking Protocol 208 do not need to be time constrained, the number of asynchronous Allocated Channel Time (ACT)s (i.e., ACT-2 308) can be scheduled at the base-rate (one per superframe), super-rate (more than one per superframe), or sub-rate (one per multiple superframes). Because the Allocated Channel Time (ACT) is an intrinsic part of the Time Division Multiple Access (TDMA) protocol, no other traffic is allowed to interfere with the permitted data transfer using that assigned Allocated Channel Time (ACT), thereby creating a deterministic means of co-existence and concurrent operation with other types of traffic in different Allocated Channel Times (ACTs) within a Superframe 301.

In the example shown in FIG. 4, time slot 1 (ACT-1) 307 is allocated for sending isochronous data (e.g., HDTV stream), time slot 2 (ACT-2) 308 is reserved for IEEE 802.11 asynchronous data traffic, and time slot 3 (ACT-3) 309 is assigned to a Power Line Communication (PLC) application, such as HomePlug® and HomePlug® AV types of traffic. Within the ACT-1 307 time slot, one or more Isochronous Member Devices (IMD) 102 are allowed to exchange isochronous data traffic to and from the Multimode Network Controller (MNC) 101 or among themselves. When information exchanges are done directly between the Member Devices (MDs) without going through the Multimode Network Controller (MNC) 101, such information exchanges are referred to as Peer-to-Peer Communication (PPC). To enable multiple Isochronous Member Devices (IMD) 102 to send and receive isochronous data, different methods may be used, such as the Multimode Network Controller (MNC) 101 allocating an isochronous Allocated Channel Time (ACT) for each Isochronous Member Device (IMD) 102 that intends to transmit isochronous data, or multiplexing isochronous data of different destinations within the ACT-1 307.

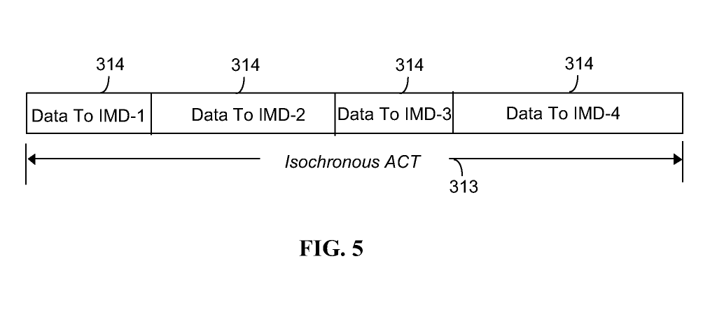

Referring now to FIG. 5, an example of data multiplexing within a single Isochronous Allocated Channel Time (IACT) 313 is shown. In this example, the Multimode Network Controller (MNC) 101 intends to send isochronous data to four different Isochronous Member Devices (IMD) 102. To maximize the efficiency of channel time utilization, the Multimode Network Controller (MNC) 101 multiplexes isochronous data destined to each Isochronous Member Device (IMD) 102 within a single Isochronous Allocated Channel Time (IACT) 313. Depending on the size of the isochronous data for an individual Isochronous Member Device (IMD) 102, the Multimode Network Controller (MNC) determines the size of a Multiplexed Data Allocation (MDA) 314 using the following steps:

First, the Multimode Network Controller (MNC) 101 receives requests from one or more Isochronous Information sources for sending isochronous data to four specific Isochronous Member Devices (IMD) 102. The Multimode Network Controller (MNC) 101 determines if all intended destination Isochronous Member Devices (IMDs) 102 are available. The Multimode Network Controller (MNC) 101 rejects a request for an unavailable Isochronous Member Device (IMD) 102 by notifying the Isochronous Information Source with a specific error message.

Second, the Multimode Network Controller (MNC) 101 gathers required QoS parameters from the request, or use predefined QoS parameters for a request made over a specific connection (such as an analog Audio-Video Link 211). The required QoS parameters include, but are not limited to, end-to-end delay, jitter, throughput, error rate, etc.

Third, the Multimode Network Controller (MNC) 101 establishes an Isochronous Allocated Channel Time (IACT) 313 for the intended isochronous data transfers based on the gathered QoS parameters. To accommodate instantaneous peak throughputs, the Multimode Network Controller (MNC) 101 over-allocates the Isochronous Allocated Channel Time (IACT) 313. For example, if the average data throughputs for individual Isochronous Member Devices (IMD) 102 are 2 Mbps (Mega Bits Per Second), 3 Mbps, 1 Mbps and 4 Mbps, respectively, the Multimode Network Controller (MNC) 101 allocates the Isochronous Allocated Channel Time (IACT) 313 that can support more than 10 Mbps of the aggregated throughput.

Fourth, after the end of the current Isochronous Allocated Channel Time (IACT) 313, if one has already been scheduled, and prior to the start of the next Isochronous Allocated Channel Time (IACT) 313, the Multimode Network Controller (MNC) 101 checks if data is available from any of the Isochronous Information Sources for transfer to specific Isochronous Member Devices (IMD) 102. If data is available for all intended destination Isochronous Member Devices (IMDs) 102, the Multimode Network Controller (MNC) 101 transmit the data to each Isochronous Member Device (IMD) 102 in a properly calculated Multiplexed Data Allocation Slot (MDAS) 314.

Fifth, if data is not available for all intended Isochronous Member Devices (IMD) 102, the Multimode Network Controller (MNC) 101 adjusts the individual Multiplexed Data Allocation Slots (MDAS) 314 to fill the entire Isochronous Allocated Channel Time (IACT) 313 reserved for this application. For example, if data is available only for IMD-1, which has an average throughput requirement at 2 Mbps, the Multimode Network Controller (MNC) 101 can allow the entire Isochronous Allocated Channel Time (IACT) 313 be used for sending data to IMD-1, thereby increasing the throughput to a minimum of 10 Mbps, assuming IMD-1 is able to support this throughput increase.

In some situations the Multimode Network Controller (MNC) 101 over-allocates an Isochronous Allocated Channel Time (IACT) 313 excessively, or the amount of the original IACT 313 requested by an Isochronous Member Device (IMD) 102 has become more than it needs, the Multimode Network Controller (MNC) 101, through its intelligent scheduling process, can recover unused channel time and assign it to another Isochronous Member Device (IMD) 102 or to an Asynchronous Member Device (AMD) 103. The Multimode Network Controller (MNC) 101 constantly monitors traffic loading for each assigned IACT 313 and can detect the idle time. If the idle time for a specific IACT 313 exceeds a predefined number of Superframe 301 cycles, the Multimode Network Controller (MNC) 101 can either autonomously adjust the size of that assigned IACT 313, or send an ACT modification command to the IMD using that IACT 313. The Multimode Network Controller (MNC) 101 reclaims the unused or idle time from the modified IACT 313, and assigns it to another Member Device that needs additional time for information transfer.

Turning back to FIG. 4, within the ACT-2 308 time slot, asynchronous data traffic can be exchanged between client stations (STA) 114 and the Multimode Network Controller (MNC) 101 acting as the Wi-Fi Access Point (AP) 113. Similarly, within the ACT-3 309 time slot, either asynchronous or isochronous data traffic can be exchanged between the Multimode Network Controller (MNC) 101 acting as the PLC Modem Controller 117 and Power Line Modems (PLM) 106. When the ACT-3 309 is reserved for PLC asynchronous data traffic, the MNC 101 acting as the PLC Modem Controller 117 may transmit a different form of Asynchronous Beacon Signal (ABS) to the Power Line Modems (PLMs) 106 to synchronize timing and the Asynchronous Networking Protocol 208. The Multimode Network Controller (MNC) 101 may also allocate an additional time slot for network management traffic in the current Superframe 301. The Management Allocated Channel Time (MACT) 306, which uses either the Isochronous Networking Protocol 207 or Asynchronous Networking Protocol 208, or a combination of both, allows the Multimode Network Controller (MNC) 101 to send or receive specific network management and control traffic, such as a request to member devices to move to a different RF channel.

When Peer-to-Peer Communication (PPC) is enabled between one Member Device (MD) and another using the same networking protocol, the Multimode Network Controller (MNC) 101 only functions as a scheduler by scheduling a proper Allocated Channel Time (ACT) for them. The PPC MDs exchange information directly between themselves without having to send the data to the Multimode Network Controller (MNC) 101 first. However, the Multimode Network Controller (MNC) 101 can continue to exchange management information with the PPC MD using the Management Allocated Channel Time (MACT) 306. Once the Multimode Network Controller (MNC) 101 schedules the ACT for the PPC MDs, the same ACT will repeat at its predefined interval until it is modified or terminated by the occupying PPC MD.

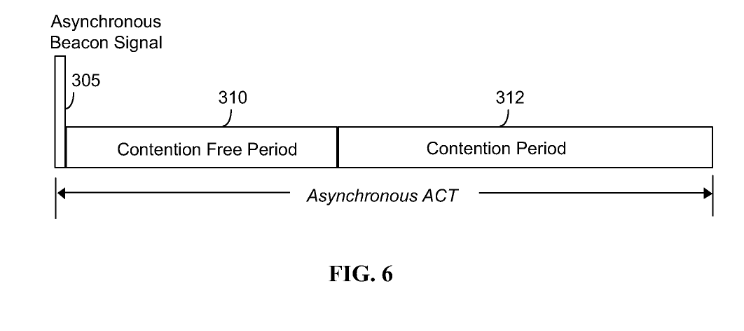

Referring now to FIG. 6, an access architecture for a typical asynchronous networking system is shown. A typical asynchronous networking system, such as Wi-Fi, allows multiple Asynchronous Member Devices (AMD) 103 to access the network for information transfers using either the contention-less mechanism during the Contention Free Period (CFP) 310, or CSMA (Carrier Sense Multiple Access)-type access method during the Contention Period (CP) 312, after the Asynchronous Beacon Signal (ABS) has been detected and validated. A typical local-area type of asynchronous networking system, such as Wi-Fi, is normally designed to provide fairness of network access to all network Member Devices (MD). Despite the fact that the CFP 310 in the asynchronous networking system allows the AMD 103 to access the network in a contention-free environment to avoid any collision and interference with other member devices, the network controller (i.e., Wi-Fi Access Point) cannot always guarantee the availability of a CFP 310 for a specific AMD 103 and its repetitiveness at a predefined interval, especially when loading on the network is high (e.g., many network users). As a result, the CFP 310 in an asynchronous networking system cannot always be used to guarantee the Quality of Service (QoS) for isochronous applications (e.g., audio and video systems).

The means of concurrent asynchronous and isochronous operation in the preferred system allows the same physical medium or channel to be used for communications with both asynchronous and isochronous member devices on the network, therefore providing maximum efficiency for channel utilization. The ability of the Multimode Network Controller (MNC) 101 to support different asynchronous and isochronous networking protocols 208 and 207 respectively allows the non-interoperable networks to continue to operate independently on the same physical medium, while maintaining backward compatibility of the systems. The preferred system is also capable of forward compatibility by allowing new classes of Member Devices (MD) on the network. Such a Member Device (MD) may be a VoIP (Voice over Internet Protocol) device or include meshing capability (i.e., the addition of new sets of Member Devices (MDs) in one or more sub-networks via their respective network controllers). In addition to using the same physical medium in the preferred system for efficient channel utilization, the system also allows a hybrid of different physical mediums, wired and wireless, to be co-located, so that communications can be shared between these different physical mediums (e.g., Wi-Fi and PLC). The preferred system employs a “fail-over” mechanism, such that when adverse conditions arise in one medium causing the link to “fail,” the mechanism will allow traffic to be routed “over” to another medium while preserving network timing and data integrity. Such adverse conditions may include, but are not limited to, the medium ceasing to function, all bandwidth being used, and degradation of channel quality to an unacceptable level. The Multimode Network Controller (MNC) 101 keeps track of what physical media are available for a given MD in its Device Information Base (DIB) 122 by periodically detecting and evaluating any alternative physical medium for that MD. A “fail-over” will not occur if the MD does not have a connection to an alternative physical medium and its current physical medium ceases to operate. If a particular MD has active connections to both primary and secondary physical media, a “fail-over” may not occur if the MD supports only one networking protocol on the primary physical medium, but a different one on the secondary physical medium. For example, if the MD operates only the Asynchronous Networking Protocol 208 on its wireless link and only the Isochronous Networking Protocol 207 on its wired connection, it may not be able to operate its isochronous application (e.g., multimedia application) on the wireless medium if the wired medium fails because it may not be able to maintain the QoS requirement for the isochronous application. Since the Multimode Network Controller (MNC) 101 has all the information about each MD in its DIB 122, it can make a decision of whether or not the switch should occur solely on its own, or in conjunction with the MD, based on the available bandwidth of the secondary physical medium and all relevant QoS parameters.

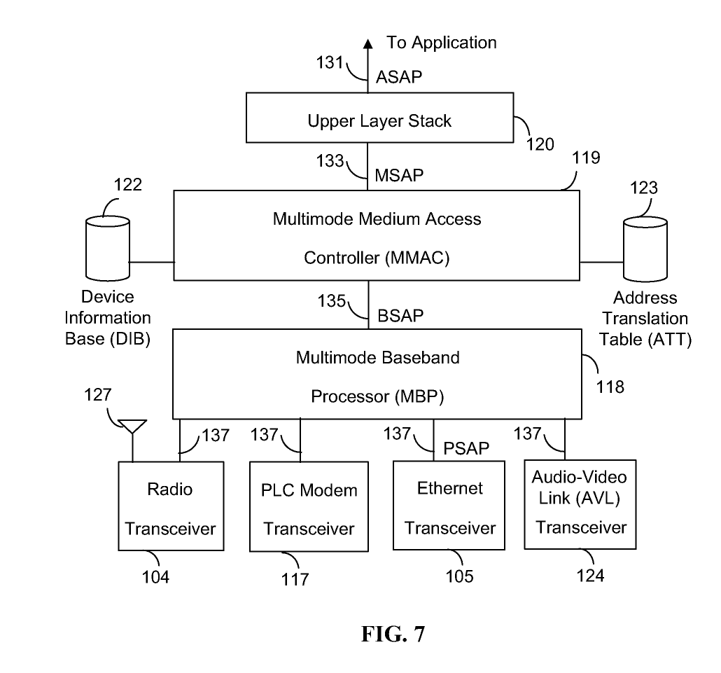

Turning now to FIG. 7, the Multimode Network Controller (MNC) 101 of the preferred system is shown to comprise an Upper Layer Stack (ULS) 120, a Multimode Medium Access Controller (MMAC) 119, a Multimode Baseband Processor (MBP) 118, and multiple physical layer transceivers, including but not limited to a Radio Transceiver 104, a PLC Modem Transceiver 117, an Ethernet Transceiver 105, and an Audio-Video Link (AVL) Transceiver 124, along with the Device Information Base (DIB) 122 and the Address Translation Table (ATT) 123. Multiple Multimode Network Controller (MNC) Antennas 127 may be used with the Radio Transceiver 104, so optimal RF performance can be achieved by means of antenna diversity, MIMO (Multiple Input Multiple Output) and others. The ULS 120 is typically a software stack that interacts with the application entity via the Application Service Access Point (ASAP) 131 and provides application specific transactions to ensure end-to-end data delivery and presentation. The MMAC 119 provides the mechanism to handle inbound and outbound data traffic of different types, asynchronous and isochronous, and interfaces with the ULS 120 via the MAC Service Access Point (MSAP) 133 and the MBP 118 via the Baseband Service Access Point (BSAP) 135. The MBP 118 is capable of modulating and demodulating the data sent to and received from its respective physical-layer transceivers via the Physical-layer Service Access Point (PSAP) 137. The MMAC 119, in conjunction with the MBP 118 and ULS 120, enables the MNC 101 to receive asynchronous inbound traffic from the Internet 201 via the Ethernet Transceiver 105, and disburse that traffic to both asynchronous and isochronous outbound channels, wired or wireless by means of the respective Ethernet Transceiver 105, PLC Modem Transceiver 117, Audio-Video Link (AVL) Transceiver 124, or Radio Transceiver 104. For example, one can watch streaming videos from the Internet 201 on a Portable PC 115 via a Wi-Fi Radio Transceiver 104, or on a plasma TV via isochronous means (e.g., AVL Transceiver 124).

The Multimode Medium Access Controller (MMAC) 119 maintains a database, Device Information Base (DIB) 122, containing all relevant information for Member Devices (MD) that are associated with the MNC 101. Information related to a specific Member Device (MD) include, but are not limited to: Device Identification Number (DIN), Device Unique Address (DUA), Device Networking Protocol (DNP), Primary Physical Medium (PPM), Secondary Physical Medium (SPM), etc., and is captured and stored in the DIB 122 during the association process, in which the Member Device (MD) makes a request to the Multimode Network Controller (MNC) 101 to become a member of the current network. The MMAC 119 updates its DIB 122 records periodically by sending out a Device Discovery or Device Probe command to specific MDs. Upon receiving such a command from the Multimode Network Controller (MNC) 101, the Member Device (MD) reports any related characteristic changes from the association process or the last update to the Multimode Network Controller (MNC) 101. The periodicity of the DIB 122 update is based on a predefined parameter. Because different addresses may be assigned to or used by the Member Device (MD), address translation needs to be properly performed by the Multimode Network Controller (MNC) 101. The MMAC 119 has mechanisms to perform address translation and protocol conversion between the Asynchronous Member Device (AMD) 103 and the Isochronous Member Device (AMD) 102 using the information from its Address Translation Table (ATT) 123. The MMAC 119 assigns a local IP (Internet Protocol) address to each associated Member Device (MD), regardless of its type, and the Address Translation Table (ATT) 123 contains the mapping data between a Member Device's IP address and its Device Unique Address (DUA). The information in the Address Translation Table (ATT) 123 is updated when there is a change in the network membership. For example, when a Member Device (MD) is disconnected from the network, its assigned local IP address will be removed from the Address Translation Table (ATT) 124 and reclaimed by the Multimode Medium Access Controller (MMAC) 119. The reclaimed local IP address can be reused and assigned to a new Member Device (MD) joining the network. The address and protocol translation is not needed for the Peer-to-Peer Communication (PPC) because the Multimode Network Controller (MNC) 101 does not receive information packets from the Peer to Peer Communication (PPC) Member Devices (MDs).

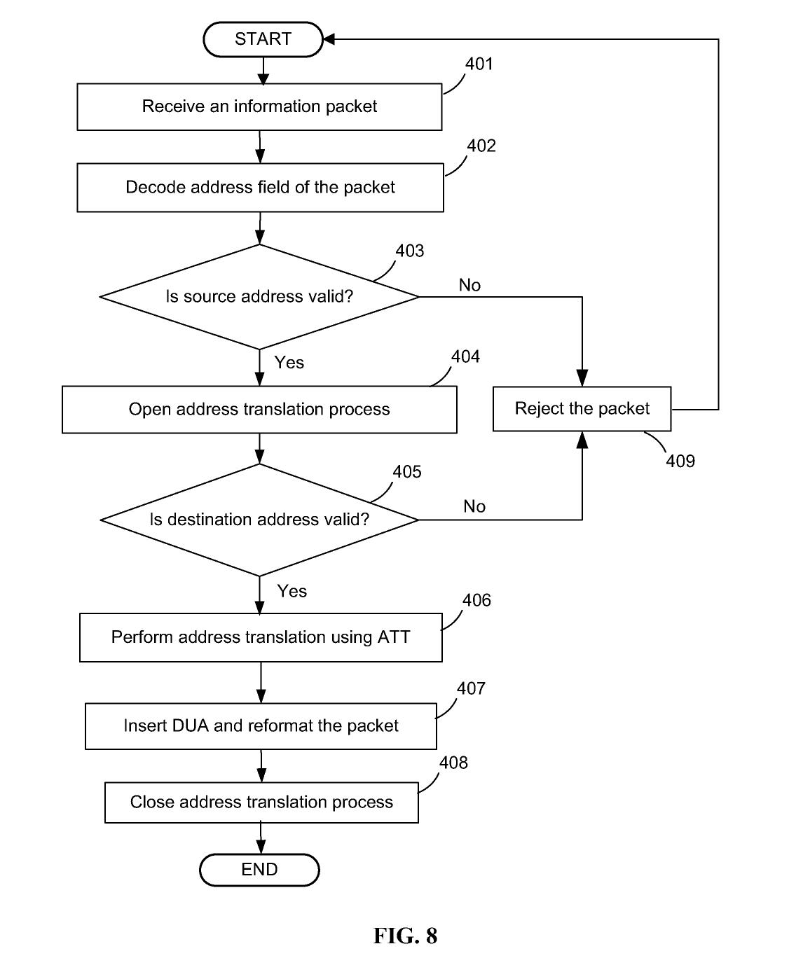

Referring now to FIG. 8, a flow chart depicting the process of address translation is shown. To translate the local IP address for a targeted destination Member Device (MD) to its Device Unique Address (DUA), the following steps are taken:

First, in 401, the Multimode Medium Access Controller (MMAC) 119 receives an information packet from a sender device via its respective physical medium. The sender device can be any of the asynchronous or isochronous information sources, or a member device (Asynchronous Member Device 103 or Isochronous Member Device 102).

Second, the Multimode Medium Access Controller (MMAC) 119 decodes the address field of the received packet in block 402. The address field typically consists of the source address and destination address. The source address is the address of the sender device and, depending on the type of networking protocol used between the Multimode Network Controller (MNC) 101 and the sender device, it may be an IP address for a standard IP-based protocol, or a Device Unique Address (DUA) for a non-IP based protocol. The destination address is usually the destination device's local IP address, which was assigned to the device during the association process.

Third, the Multimode Medium Access Controller (MMAC) 119 checks and validates the source address of the sender device in block 403 by verifying its entry in the Device Information Base (DIB) 122. If the source address is invalid, the Multimode Medium Access Controller (MMAC) 119 rejects the received packet and de-queues it from its memory buffer in block 409.

Fourth, in block 404, the Multimode Medium Access Controller (MMAC) 119 starts the address translation process after it validates the source address. The Multimode Medium Access Controller (MMAC) 119 checks whether or not the destination address has a valid entry in the Address Translation Table (ATT) 123 in block 405. If the destination address is unknown, the MMAC 119 rejects the received packet in block 409 and, depending on the type of networking protocol used, may notify the source device of its rejection.

Fifth, after the Multimode Medium Access Controller (MMAC) 119 validates the destination address, which is a valid local IP address for the intended destination device, it starts performing address translation in block 406. The valid local IP address is mapped to the Device Unique Address (DUA) according to the corresponding entry in the Address Translation Table (ATT) 123.

Sixth, in block 407, the Multimode Medium Access Controller (MMAC) 119 replaces the local IP address in the destination address field of the received packet with the mapped Device Unique Address (DUA) for the destination device. The MMAC 119 also reformats the packet and encapsulates the data in the appropriate protocol frame used by the destination device. The Multimode Medium Access Controller (MMAC) 119 then makes the reformatted packet ready for transmission and closes the address translation process in block 408.

Additionally, the Multimode Medium Access Controller (MMAC) 119 in the preferred system has the ability to provide a mechanism for aggregating adjacent physical (RF) channels to increase the system bandwidth and thereby the data throughput. Frequency division is often used in RF communications, such that a specific radio frequency band allocated for the communication systems can be divided into smaller radio channels for transmission. For example, a Wi-Fi system can use either 2.4 GHz or 5 GHz band, and in the case of 2.4 GHz band, 11 radio channels are made available for data communication between the Wi-Fi Access Point (AP) 113 and the Station (STA) 114. Depending on the application throughput requirement and availability of the radio channels, the Multimode Medium Access Controller (MMAC) 119 may issue a request to the Multimode Baseband Processor (MBP) 118 to combine the current RF channel with one or two of its adjacent channels for an increased throughput. Combining the current RF channel (e.g., Channel 5) with one of its adjacent channel (e.g., Channel 4) may double the original throughput, and combining with both of its adjacent channels (e.g., Channels 4 and 6) may effectively increase the throughput by three times. The MBP 118 upon receiving the request from the Multimode Medium Access Controller (MMAC) 119 starts scanning all available channels within the frequency band. If adjacent channels are found available and idle, the MBP 118, in conjunction with the Radio Transceiver 104, begin aggregating adjacent channels. If no adjacent channels are found available and idle, the MBP 118 will notify the Multimode Medium Access Controller (MMAC) 119 using an appropriate Baseband Service Access Point (BSAP) 135 response.

Because of the periodicity and synchronization associated with individual Allocated Channel Time (ACT) slots in the preferred system, the Member Device (MD), either the Asynchronous Member Device (AMD) 103 or the Isochronous Member Device (IMD) 102, can enter the sleep mode when communication with the network is not expected. This enables important power savings and minimizes interference in the network. The Isochronous Member Device (IMD) 102 knows when it should wake up to listen to the next Synchronous Beacon Signal (SBS) 303 and/or to exchange isochronous traffic in its designated ACT-1 307. Similarly, the Asynchronous Member Device (AMD) 103 wakes up periodically (a predefined parameter) to listen to the Asynchronous Beacon Signal (ABS) 305. While in sleep mode, a portable MD (either Asynchronous Member Device (AMD) 103 or Isochronous Member Device (IMD) 102) can switch off most of its power, thereby improving battery life.

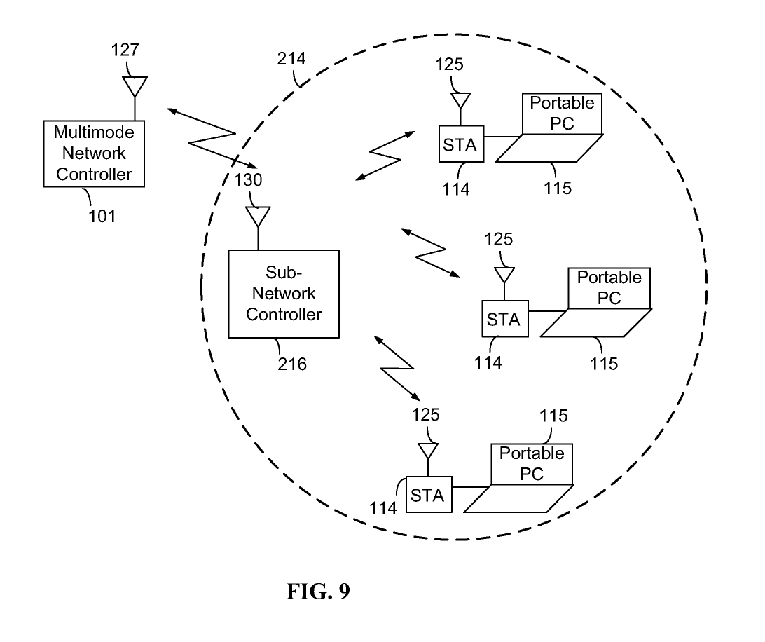

Turning now to FIG. 9, a diagram of a Sub-Network 214 is shown. In addition to the direct Peer-to-Peer Communication (PPC) between Member Devices (MD) using the same networking protocol, an Allocated Channel Time (ACT) assigned to a Member Device (MD) can be used for any other purpose in the preferred system. A new class of an MD with 802.11 Access Point (AP) capability, can use its assigned ACT (i.e., ACT-2 308) to establish a Sub-Network 214 and become a Sub-Network Controller (SNC) 216 to communicate with Stations (STA) 114 within its own Sub-Network 214. The SNC 216 can relay information from the Multimode Network Controller (MNC) 101 to another MD (or STA 114) that is in range of the SNC 216 but not with the MNC 101. Similarly, a new class of an asynchronous or isochronous MD having mesh controller functionality can first of all request an ACT be established with the MNC 101, and use that ACT to start its own Sub-Network 214 and become the SNC 216 for other MDs. This effectively extends the range of the MNC 101 and also minimizes interference from different MDs. The SNC 216 therefore communicates with the MNC 101 on one RF channel and with its Sub-Network 214 MDs on a different RF channel. The SNC 216 may establish its Sub-Network 214 as a Closed Member Group (CMG), such that the MDs of the Sub-Network 214 are not aware of, and/or cannot communicate with, any other MDs outside of the Sub-Network 214. The SNC 216 can also make its Sub-Network 214 a non-CMG, such that it can broadcast to all its Sub-Network 214 MDs about the other MDs outside of the Sub-Network 214 and permit communications in and out of the Sub-Network 214. When a Sub-Network 214 MD is allowed to communicate with another MD outside of the Sub-Network 214, the SNC 216 may relay the information packets between the Sub-Network MD and the MNC 101 before the end of the current ACT-2 308, or during the next ACT-2 308. No Peer-to-Peer Communication (PPC) is allowed between the Sub-Network 214 MD and another MD outside of the Sub-Network 214, or between the SNC 216 and the outside MD. To extend the coverage range farther, an MD at the boundary of a Sub-Network 214 can establish an additional sub-network. Therefore, multiple layers of the Sub-Network 214 can be created by different SNCs 216 at the boundary of their respective Sub-Networks 214. Each SNC 216 of this multi-layer sub-network can subdivide the original ACT from the MNC 101 for its own Sub-Network MDs to use. This enables an MD in the outer-most Sub-Network 214 to communicate with an information source connected directly to the MNC 101. Through the association process, the MNC 101 can gather and store all relevant device information relating to that MD in its Device Information Base (DIB) 122. Information transfers between the information source and the outer-most sub-network MD may incur additional delays as the information has to traverse multiple Sub-Networks 214. To minimize the delay for an isochronous application, the Multimode Medium Access Controller (MMAC) 119, in conjunction with the Upper Layer Stack (ULS) 120, in the MNC 101 employ different techniques, such as using the shortest path to route the information to the intended destination, dynamically changing the transmission window, or use the combination of data aggregation and buffer management.

Various embodiments of the present invention thus provide a solution to the problem of managing communications in a home environment where the home user is connected to multiple sources of information which may transmit asynchronously or isochronously, such as the Internet or digital television, respectively. Various embodiments of the present invention provide a Multimode Network Controller (MNC) 101 that distributes received information and communicates with member devices using Time Division Multiple Access (TDMA) techniques without changing the native protocols of the Member Devices (MD). The Multimode Network Controller (MNC) 101 establishes logical channels of communication with the Member Devices (MDs). Information is exchanged between the Multimode Network Controller (MNC) 101 and Member Devices (MDs) via the logical channels. The Multimode Network Controller (MNC) 101 has one or more suitable algorithms or other processes or applications that manage Allocated Channel Time (ACT) slots in a Superframe 301. Each Superframe 301 has one master beacon (i.e., Synchronous Beacon Signal 303). Following the master beacon are one or more time slots (Allocated Channel Time) for isochronous and asynchronous communication. Within each time slot, the information is communicated to the member device in the native protocol of that member device. The Multimode Network Controller (MNC) 101 may assign one or more of the time slots to a given Member Device (MD) depending upon the volume and type of traffic (asynchronous or isochronous) between the sources and the Member Devices (MDs). The particular algorithms and processes for monitoring and allocating time slots are within the capability of one skilled in the art of TDMA systems. For example, see U.S. Pat. Nos. 6,973,067, 6,970,448, and 6,967,946 whose disclosures are herein incorporated by reference. As such, various embodiments of the present invention may establish and maintain a home user network that employs a variety of different native protocols as well as different physical media for communication, including wired or wireless media.

What is claimed is:

1. A digital communication system comprising network nodes and connections to multiple asynchronous and isochronous information sources, the network nodes having a Multimode Network Controller and at least two normally non-interoperable Member Devices with different native protocols, the Multimode Network Controller comprising means for controlling and coordinating transfer of information from multiple asynchronous and isochronous information sources to the Member Devices, each Member Device having a transmitter and a receiver and whereas the Member Device uses its native networking protocol to communicate with the Multimode Network Controller to transfer information between the Multimode Network Controller, asynchronous and isochronous information sources, or Member Devices.

2. The digital communication system according to claim 1, wherein the Multimode Network Controller uses a TDMA (Time Division Multiple Access)-based technique for establishing and maintaining communications with one of the Member Devices (MDs) over one physical channel and with another Member Device (MD) over the same or different physical channel.

3. The digital communication system according to claim 1, wherein the networking protocol between the Multimode Network Controller and one Member Device is asynchronous in nature.

4. The digital communication system according to claim 1, wherein the networking protocol between the Multimode Network Controller and one Member Device is isochronous in nature.

5. The digital communication system according to claim 1 further comprising an internet connection to the Multimode Network Controller.

6. The digital communication system according to claim 1, wherein the non-Internet, asynchronous information source is any computing and consumer electronics equipment that hosts and provides information over an Internet Protocol (IP)-based asynchronous connection.

7. The digital communication system according to claim 1, wherein the isochronous information sources are subscription-based content services over cable or satellite provided by content service providers, and non-subscription-based isochronous information sources from computing and consumer electronics equipment.

8. The digital communication system according to claim 7, wherein the Multimode Network Controller maintains a plurality of wired Audio-Video Link connections to content service providers by means of one or more cable/satellite Set-Top Boxes, and to non-subscription-based isochronous information sources.

9. The digital communication system according to claim 1, wherein the networking protocol used by a first Member Device is incompatible with that of a second Member Device, and each Member Device communicates with the Multimode Network Controller using its native networking protocol over a physical channel.

10. The digital communication system according to claim 1, wherein a first Member Device communicating with the Multimode Network Controller using an isochronous networking protocol is an Isochronous Member Device and a second Member Device communicating with the Multimode Network Controller using an asynchronous networking protocol is an Asynchronous Member Device.

11. The digital communication system according to claim 1, wherein the Multimode Network Controller, using its Time Division Multiple Access-based control means, receives information from an Isochronous Member Device using a native isochronous networking protocol, reassembles the information, delivers the information to the Asynchronous Member Device using a native asynchronous networking protocol over the same physical medium.

12. The digital communication system according to claim 1, wherein the Multimode Network Controller, using its Time Division Multiple Access-based control means, receives information from an Asynchronous Member Device via its native asynchronous networking protocol, reassembles the information and delivers the information to the Isochronous Member Device via its native isochronous networking protocol, over the same physical medium.

13. The digital communication system according to claim 11, wherein the information exchanged between the Isochronous Member Device and the Asynchronous Member Device crosses over different physical mediums.

14. The digital communication system according to claim 1, wherein the connections are wired physical channels, the wired physical channels being coaxial/triaxial cable, twisted-pair Ethernet wire (CAT 5), optical fiber, power line, and telephone line.

15. The digital communication system according to claim 1, wherein the connections are wireless physical channels, the wireless physical channels being radio frequency channels.

16. A method for establishing and maintaining simultaneous operation of asynchronous and isochronous communications in a digital communication system comprising the steps of:
connecting a Multimode Network Controller to multiple asynchronous and isochronous information sources and Member Devices of incompatible networks with different native protocols,
providing Time Division Multiple Access-based controls in a Multimode Network Controller for establishing and maintaining simultaneous communications with the member devices of non-interoperable protocols over one or more physical channels and
transferring information between the information sources and Member Devices that are both isochronous member devices and asynchronous member devices.

17. The method according to claim 16, wherein the Multimode Network Controller transfers information from the asynchronous information source to the Isochronous Member Device using an isochronous networking protocol, and to the Asynchronous Member Device using an asynchronous networking protocol, and the Multimode Network Controller autonomously decides to transfer information to the Isochronous Member Device over a physical channel and to the Asynchronous Member Device over a physical channel.

18. The method according to claim 16, wherein the Multimode Network Controller maintains a database containing all Member Devices associated with the Multimode Network Controller and the Multimode Network Controller performs proper address translation and protocol conversion between the Asynchronous Member Device and the Isochronous Member Device.

19. The method according to claim 16, wherein the Multimode Network Controller transfers information from a first Member Device operating on a wired physical medium to a second Member Device operating on a wireless physical medium.

20. The method according to claim 16 wherein the Multimode Network Controller establishes a single logical communication channel with a Member Device, the single logical communication channel being time synchronized and repeated at a pre-determined interval, the logical communication channel, also known as Superframe, comprises a Synchronous Beacon Signal and one or more time slots, also known as Allocated Channel Time.

21. The method according to claim 16 wherein the Multimode Network Controller transmits a Synchronous Beacon Signal at the beginning of each Superframe cycle heard by an Isochronous Member Device and followed by one or more assigned Allocated Channel Time.

22. The method according to claim 21, wherein the Allocated Channel Time allocates sufficient time for transferring information between the Multimode Network Controller and the Member Devices, the information being application data traffic of asynchronous or isochronous nature or network management traffic.

23. The method according to claim 16 wherein the Allocated Channel Time is allocated for transferring QoS-demanding information between the Multimode Network Controller and Isochronous Member Devices and between one Isochronous Member Device and another Isochronous Member Device, said information being isochronous data traffic comprising time sensitive audio video data.

24. The method according to claim 16, wherein the Multimode Network Controller transmits an Asynchronous Beacon Signal at the beginning of an Allocated Channel Time reserved for asynchronous data traffic.

25. The method according to claim 16 wherein the Asynchronous Member Device listening to the designated physical channel detects the presence of an Asynchronous Beacon Signal and receives information from the Multimode Network Controller or contends for accessing the asynchronous physical channel, said information transferred being asynchronous data traffic comprising Internet Protocol (IP) data.

26. The method according to claim 16 wherein the Multimode Network Controller intelligently schedules Allocated Channel Time adaptive for asynchronous and isochronous data traffic, providing efficient utilization of limited bandwidth within the constraints of the physical channels, and based on system loading and traffic priority dynamically schedules the number of asynchronous Allocated Channel Time at the base-rate (one per superframe), super-rate (more than one per superframe), or sub-rate (one per multiple superframes).

27. The method according to claim 26 wherein the Multimode Network Controller, through an intelligent scheduling process, recovers unused bandwidth and channel time and reassigns the unused bandwidth and channel time to either an Asynchronous Member Device or an Isochronous Member Device to improve throughput performance.

28. The method according to claim 16, wherein both the Asynchronous Member Device and the Isochronous Member Device communicate with the Multimode Network Controller, and with each other and other compatible networks, transparently using their native networking protocols without changes.

29. The method according to claim 16 wherein a new unmodified Isochronous Member Device, having moved into range of the Multimode Network Controller, detects a Synchronous Beacon Signal, synchronizes with the Superframe, and communicates with the Multimode Network Controller or other Member Devices.

30. The method according to claim 16 wherein a new unmodified Asynchronous Member Device, having moved into range of the Multimode Network Controller, detects an Asynchronous Beacon Signal, synchronizes with the Allocated Channel Time reserved for the asynchronous networking protocol, and communicates with the MNC or other Member Devices.

31. The method according to claim 16 wherein the Multimode Network Controller assigns Allocated Channel Time to new classes of Member Devices, the Member Devices having either asynchronous or isochronous characteristics.

32. The method according to claim 16, wherein the Multimode Network Controller aggregates two or more adjacent wireless physical channels for transferring of information to the Member Device at an increased rate and throughput.

33. The method according to claim 16 wherein the Member Device only communicates with the Multimode Network Controller or another Member Device at a pre-determined time interval in the Allocated Channel Time reserved for the Member Device's information transfer and outside of that interval switches off power to non-vital parts.

34. The method according to claim 16, wherein a Wi-Fi Access Point as a new class of Member Device, capable of including mesh controller functionality, establishes a wireless sub-network and becomes a Sub-Network Controller (SNC).

35. The method according to claim 34, wherein a new Allocated Channel Time is assigned by the Multimode Network Controller to the Sub-Network Controller, the Sub-Network Controller being the bridge between the Multimode Network Controller and one or more Sub-Network Member Devices that are not in range of the Multimode Network Controller, and wherein the transferring of information between the Multimode Network Controller and the Member Device of the sub-network is relayed by the Sub-Network Controller within the Allocated Channel Time reserved for sub-network communication.

36. The method according to claim 16 wherein the Multimode Network Controller routes both asynchronous and isochronous network traffic between a wired physical medium and a wireless physical medium in the event that the original physical medium no longer supports information transfer.

37. The method according to claim 16 wherein the Multimode Network Controller multiplexes data received from Isochronous Information Sources for multiple Isochronous Member Devices by creating Multiplexed Data Allocation Slots within an Isochronous Allocated Channel Time, said Multiplexed Data Allocation Slots being adjusted by the Multimode Network Controller to maximize the efficiency of channel time utilization.
